(19) United States
(12) Patent Application Publication
(10) Pub. No.: US 2017/0327414 A1
(43) Pub. Date: Nov. 16, 2017

(54) METHOD FOR PRODUCING A COATING LAYER COATED ONTO THE INNER SURFACE OF A CONTAINER AND A CONTAINER OBTAINED WITH SUCH A METHOD

(71) Applicant: GLASS SURFACE TECHNOLOGY, Paris (FR)

(72) Inventor: Christophe Wagner, Paris (FR)

(73) Assignee: GLASS SURFACE TECHNOLOGY, Paris (FR)

(21) Appl. No.: 15/529,323

(22) PCT Filed: Nov. 26, 2015
(86) PCT No.: PCT/FR2015/053241

§ 371 Date: May 24, 2017

(30) Foreign Application Priority Data
Nov. 26, 2014 (FR) 1461531

(51) Int. Cl. C03C 17/00; C23C 18/12; C03C 17/25

(52) U.S. Cl. CPC C03C 17/004; C23C 18/1283; C23C 18/1254; C23C 18/1233; C03C 17/25; C23C 18/122; C23C 18/1225; C03C 2217/213; C03C 2218/113

(57) ABSTRACT

A method for producing a layer for coating the inner surface of a container and a glass or plastic container obtained by said method, wherein said container is suitable for containing products biocompatible with humans and/or animals. The method includes: forming a solution containing a solvent, water, a molecular precursor comprising alkoxy groups and an acid as a catalyst, mixing said solution to initiate hydrolysis and condensation, applying the resulting solution onto at least one portion of the inner surface of the container, while the solution is in the process of gelling, the resulting applied solution is then dried at a temperature for a predetermined time, before curing. The acid is citric acid, wherein said citric acid is at a concentration of less than 6 mol/l, and in that the solution comprises less than 1.5 units of precursor for each volume unit of acid.

The present invention relates to a process for the manufacture of a layer for coating the internal face of a container.

It also relates to a container obtained with such a process.

Manufacture of a layer for coating the internal face of a container is understood to mean the manufacture of a covering solution which forms, after gelling and then solidification, a layer of protective material, and also the covering proper, that is to say the surface affixing of such a solution to the surface of an object formed of another material, in order to create, after gelling and curing, this protective layer in an integral and lasting fashion (that is to say, lasting more than several years). Such a coating then modifies the physical and/or chemical surface properties of this other material (when it comes back into contact with a product).

The invention has a particularly important although nonexclusive application in the field of the manufacture of bottles intended to receive and preserve processed foodstuffs, pharmaceutical products or cosmetic products.

It makes it possible in particular to minimize container/contents and/or environment/contents interactions, more particularly for storage in glass bottles, requiring the preservation of products in a neutral fashion for a fairly long time (for example several months).

Conventionally, neutral glass is understood to mean a glass which, over time, releases ions, for example sodium ions or other alkali metal and/or alkaline earth metal ions, in a very small amount into the liquid or product which is inside the container.

Very small amount is understood to mean a ratio of weight of the liquid contained and total weight of the extractable elements of less than 6 ppm.

Soda-lime glass, for example, is not neutral within the meaning of the Pharmacopeia.

It is thus known that, when a glass bottle is manufactured, it is necessarily brought to high temperatures.

The latter result in particular in a migration of the alkali metals (in the case of a silicate glass), which rise to the surface of the glass and/or to its immediate proximity, and in a manner sufficient to be subsequently exposed to the contents of the container.

In point of fact, the amounts of alkali metal, although generally very small, are harmful in the case of bottles intended to contain vaccines or active principles, which have to remain pure.

This is because the alkalinity may cause dangerous effects with regard to a pharmaceutical product, as a result of unacceptable reactions which might take place between the wall of the glass and the product.

Means for preventing disadvantages of this type by the use of sulfur dioxide and/or of difluoroethane or by treatment with heat on the line for production of the glass bottles, either with sulfur or with fluorine, are already known.

The sodium sulfate generated by such treatments (white film on the internal surface of the bottles) is subsequently washed with water before filling the containers.

There are disadvantages to such processes.

This is because these processes are complex, expensive and difficult to carry out, in particular as a result of the handling of toxic and/or polluting products (for example, the treatment with sulfide requires the use of gas or powder which is difficult to handle), and not always sufficiently reliable.

It is also known (WO 2010/112792) to cover at least a fraction of an internal face of a container with a vitreous material prepared according to a process known to a person skilled in the art under the Sol-Gel (diminutive of solution-gel) name.

The vitreous material, which is based on silica, is obtained without melting, by polymerization of at least one molecular precursor.

It comprises a stage of synthesis carried out starting from alkoxides of formula M(OR)ₙ, where M is a metal or silicon and R is an organic CₙH₂ₙ₊₁ alkyl group, dissolved in a standard solvent and then a more or less lengthy stage of gelling with evaporation of the solvent until solidification is complete.

There are also known (EP 2 199 264) processes by formation of a vitrified surface layer of silicon at a high temperature.

However, such processes do not make it possible to carry out a cold (ambient temperature) coating after definitive manufacture from bottles formed.

There is also known, in fields very distant from the invention (optical and electronic fields), a process (Marek Nocum et al., “Sodium diffusion barrier coating prepared by Sol-Gel method”, Optica Applicata, 1 Jan. 2008, pages 171-179-XP055066575) in which a glass strip is coated with a Sol-Gel layer itself covered with tin.

Such a process does not leave the contents of the bottle in contact with the Sol-Gel layer and thus does not make it possible to control, by the formulation of the Sol-Gel, the protection in a confined space, such as a bottle, while limiting the residual amount of harmful elements, such as, for example, the acid.

There is also known (FR 2 886 309) a Sol-Gel formulation for a coating for a metal surface comprising organometallic elements (in particular Zi; Al; Ti) and aggressive and/or polluting acids, such as hydrochloric acid.

Such Sol-Gel processes comprise the introduction of numerous elements which are often undesired, in some cases dangerous and contrary to use in the cosmetic and/or pharmacological field.

They are in addition particularly complex and problematic to employ and they come under specific applications/uses which cannot be readily extrapolated to other situations.

Thus, they do not make it possible, in a repetitive, simple and adaptable manner, to satisfactorily coat an interior surface with a Sol-Gel barrier layer having sufficient adhesion, independently of the shape of the container.

They often require the introduction of additional elements and/or elements exhibiting a large amount of residues.

Specifically, the formulation of the solution has to make it possible to obtain a viscosity which makes possible the ready application of the solution while making possible gelling kinetics which limit the effects of the smears during application, while making possible good stability over time and not leaving cracks in the applied layer after baking.

In addition, they generally require the use of acid or base so as to activate, that is to say prepare, the surface state of the internal surface intended to be covered.

These acids, at the pH values envisaged, are very active products, indeed even dangerous products, for the technician and for the container.

The reactants of the prior art which can be used with such processes are furthermore not readily available commercially and/or are expensive, require restrictive safety procedures and impose limitations in terms of temperature, of treatment time and of materials which can be used.

Furthermore, the acids used cannot be easily discharged in a confined medium and are not removed efficiently enough when there is a rise in temperature.

The present invention is targeted at providing a process, and a container obtained by such a process, which responds better than those known previously to the practical requirements, in particular in that it does not necessarily require harmful products in order to prepare the internal wall of the bottle or of the container before treatment, in that it consequently does not require obligatory rinsing before and/or after use, in that it does not leave, on the wall, organometallic compounds (for example zirconium oxide, titanium oxide, tin oxide, aluminum oxide or mixed oxides of these), except in the case of additives specifically added for predetermined functions and with the exception of the formation of a protective barrier against releases, and in that it makes it possible to treat all types of bottles, independently of the suppliers of these, and does so while generating fewer breakages of or less damage to the containers than in the prior art, and in that it makes it possible to operate in a confined medium with application by a sprayer.

The invention also makes it possible to be used both with materials made of glass and with materials made of plastic and to obtain good reaction kinetics at the industrial level for lower treatment temperatures than in the prior art.

It is thus in particular an object of the present invention to implement these principles with the abovementioned advantages while overcoming the disadvantages of the prior art.

With this aim, it provides in particular a process for the manufacture of a coating layer for the internal face of a container suitable for containing products biocompatible with man and/or animals, in which:
a solution containing a solvent, water, a molecular precursor comprising alkoxyl groups and an acid as catalyst is formed,
the solution thus obtained is applied to at least a part of the internal face of the container, the solution being in the course of gelling,
then the solution thus applied is dried at a predetermined temperature and for a predetermined time, before baking, characterized in that the acid is nitric acid or citric acid.

These acids are relatively inexpensive and are easily removed during the process.

The invention more particularly still provides a process for the manufacture of a coating layer for the internal face of a glass or plastic container suitable for containing products biocompatible with man and/or animals, in which:
a solution containing a solvent, water, a molecular precursor comprising alkoxyl groups and an acid as catalyst is formed,
this solution is mixed in order to initiate the hydrolysis and the condensation,
the solution thus obtained is applied to at least a part of the internal face of the container, the solution being in the course of hydrolysis and condensation,
the solution thus applied is dried at a predetermined temperature and for a predetermined time, characterized in that the acid is citric acid with a concentration of less than or equal to 6 mol/l and in that, for one unit by volume of acid at said concentration, the solution comprises a volume of precursor of greater than or equal to 1 unit.

More specifically, depending on the precursor chosen, its amount in unit of volume is between 1 and 15, for example between 1 and 12.

Advantageously, the concentration of acid is less than 4 mol/l, for example less than 2 mol/l, for example 1.04 mol/l.

The drying can be carried out simultaneously with and/or subsequent to the application of the layer.

Alkoxy groups is more particularly understood here to mean alkoxyl groups, that is to say the chemical entities consisting of an alkyl group bonded to an oxygen atom.

With the invention, it is possible to handle acids extracted directly from lemon juice with great facility of use and for prices which are low in comparison with other acids.

The use of citric acid makes it possible in particular, with the invention, to leave only negligible amounts thereof remaining in the bottle, for example less than 1 ppm.

Despite the constant process of gelling/solidification, it is also possible to preserve, in the long term, the gel (partially gelled solution) produced from the above solution and to work at ambient temperature.

The release of ions by the container is greatly reduced.

In other words, the ability of a container, the internal face of which is substantially entirely covered, to withstand the release of elements is improved.

Such a result is obtained without subsequent treatment and under appropriate storage conditions, the measurements being carried out, for example, via the methods of determination provided by the standard ISO 4802-2 or by titration according to the standard ISO 4802-1.

Conventionally, the hydrolytic resistance is measured before treatment, and after treatment, by determination of the amount of sodium oxide and of other alkali metal or alkaline earth metal oxides released during a treatment in an autoclave at 121° C. for 60 minutes, the measurements being, for example, subsequently carried out in a way known per se by flame spectrometry.

With the invention, it is thus found that subsequent releases, in particular as tested in standardized fashion in an autoclave as described above, no longer make it possible to measure significant degrees of release.

In advantageous embodiments, recourse is had, furthermore, and/or in addition, to one and/or other of the following arrangements:
drying is carried out simultaneously with the application;
the drying is subsequently followed by a stage of baking within a higher predetermined temperature range;
before application, a surfactant is added to the solution;

Advantageously, the surfactant is taken from one and/or other of the following elements: polyethylene glycol, cetrimonium bromide, anionic surfactant, polyethylene glycol p-(1,1,3,3-tetramethylbutyl)phenyl ether;
drying is carried out at a temperature greater than the boiling point of the solvent and of the acid for a time of greater than 20 min while ventilating the interior of the container.

Ventilation is carried out, for example, via fans judiciously placed in a way known by a person skilled in the art.

Advantageously, the solvent is chosen in order for the boiling point to be close to that of the acid.

It should be noted that the boiling point at atmospheric pressure of nitric acid is 121° C. and of citric acid 175° C.;
the solution has a concentration of nitric acid of between 2 mol/l and 3 mol/l, advantageously 2.5 mol/l, or of citric acid of between 0.02 mol/l and 0.8 mol/l, advantageously 0.189 mol/l;
before application of the solution to the internal face, the extractable materials are extracted beforehand from said internal face by at least three passes in an autoclave with water of R or R1 quality and/or water charged with NaCl according to a concentration of between 0.5% and 1.2%;
before application of the solution to the internal face, the extractable materials are extracted beforehand from said internal face by treatment in an oven in a humid atmosphere containing sodium chloride and/or calcium gluconate dissolved in water in proportions sufficient to make possible complete dissolution of the molecules concerned;
when the container is made of glass, it is baked for a period of time of 20 to 40 min at a temperature of 450° C. to 550° C. when the acid is nitric acid and at a temperature of 530° C. to 600° C. when the acid is citric acid;
when the container is made of plastic, it is baked for a period of time of 40 to 60 min at a temperature of 90° C. to 150° C.;
3-glycidoxypropyltrimethoxysilane or tetraethyl orthosilicate is used as precursor;
2-butoxyethanol is used as solvent (its boiling point at atmospheric pressure is 172° C.);
the solvent and the precursor are mixed in proportions by weight of seven measures of solvent for one measure of water, two measures of acid at a concentration of, for nitric acid, between 10 mol/l and 18 mol/l, advantageously 15.55 mol/l, and, for citric acid, between 0.5 mol/l and 4 mol/l, advantageously 1 mol/l, and two measures of precursor;
additives suitable for carrying out a function taken from the combination of SiO₂, colored pigment, cerium oxide and/or silver are added to the mixture;
after addition of the ingredients, the solution is mixed for a period of time t of between 25 and 45 minutes at a temperature of between 15° C. and 35° C.

Ingredients is understood to mean the solvent, the water, the molecular precursor, the acid and the optional additives;
the successive stages of application of the coating solution to at least a part of said internal face, of discharge of the excess coating product and of baking of the product are repeated at least three times;
the solvent, the acid catalyst, the water and then the molecular precursor are successively mixed in order;
a treatment with an atmospheric-pressure plasma is carried out beforehand.

The invention also provides a container obtained by the process described above.

It also relates to a container comprising a wall delimiting a cavity suitable for containing products biocompatible with man and/or animals, said wall exhibiting an internal face facing said cavity, at least a part of which is covered with a solidified gel obtained from a solution containing a solvent, water, a molecular precursor comprising alkoxy groups and an acid as catalyst, characterized in that the acid is nitric or citric acid.

Advantageously, the solution comprises SiO₂, a colored pigment, cerium oxide and/or silver.

Also advantageously, it comprises a surfactant, for example taken from polyethylene glycol and/or cetrimonium bromide and/or anionic surfactants and/or polyethylene glycol p-(1,1,3,3-tetramethylbutyl)phenyl ether.

Also advantageously, the container is made of plastic or of glass.

In another embodiment, the container is made of aluminum.

A better understanding of the invention will be obtained on reading the description which follows of embodiments described below by way of nonlimiting examples and with reference to the figures which accompany it, in which:

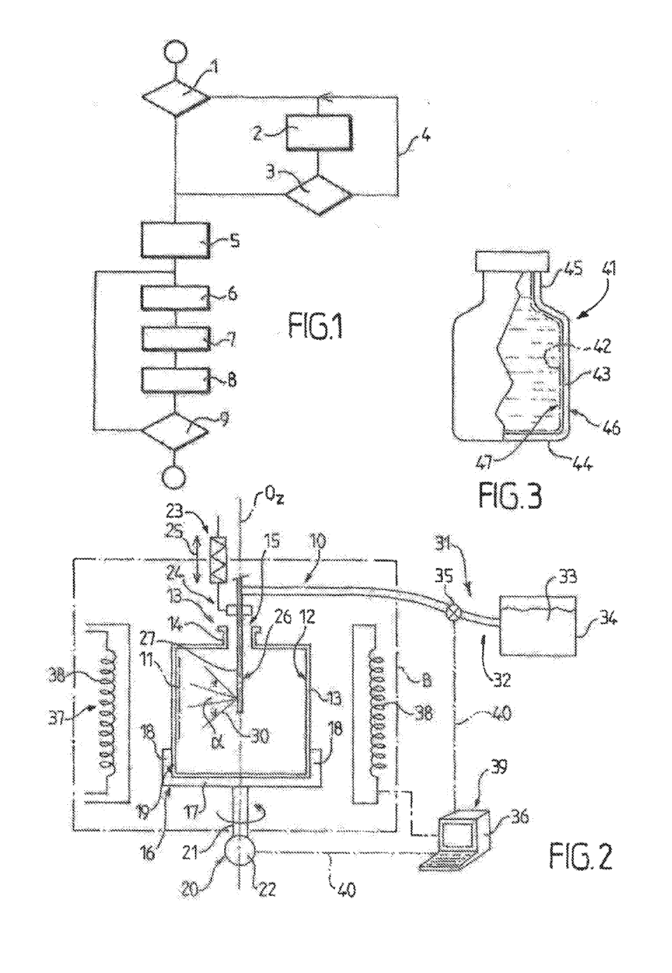

FIG. 1 is a flow diagram showing the stages of a process for the manufacture of a coating layer according to one embodiment of the invention.

FIG. 2 diagrammatically shows in section an embodiment of a device implementing the process according to one embodiment of the invention.

FIG. 3 shows in exploded partial view a container according to one embodiment of the invention.

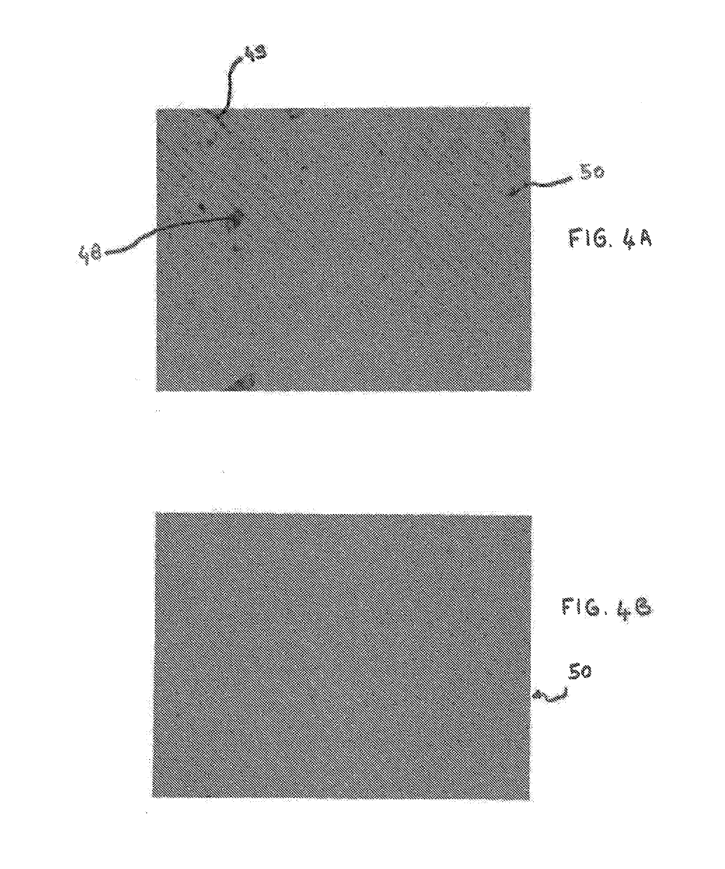

FIGS. 4A and 4B are photographs at the microscopic scale of a portion of the internal wall of a container coated with a Sol-Gel layer according to one embodiment of the invention using citric acid respectively without and with addition of surfactant elements.

FIG. 1 gives the flow diagram of the main stages of the process according to the embodiment of the invention more particularly described here.

The process comprises a preliminary stage (not represented) of supplying of at least one container or bottle to be treated.

The container is formed of a material which, suitably treated, will make it possible to contain products biocompatible with man and/or animals, that is to say compatible with ingestion and/or application to the human or animal body (medicaments, cosmetic products, and the like).

The process subsequently comprises or does not comprise (test 1) a stage 2 of passivation of the internal face of the container.

It should be remembered that passivation is understood to mean an extraction, prior to the use of the bottle, of the elements liable to exit from the internal wall of the bottle during contact with liquid or pasty contents which would be subsequently stored therein.

The extraction has to be sufficient for the measurements by weight of these elements to be below a predetermined threshold set by the standards in force.

In one embodiment, the passivation is carried out by filling with aqueous extraction liquid, for example with water of R or R1 quality, and then emptying after a predetermined time, and/or water charged with sodium chloride NaCl according to a concentration of between 0.5% and 1.2%, for example 0.9%.

In another embodiment, the container, for example stoppered with an aluminum sheet, is placed in an oven for a time of at least three hours at a predetermined temperature of more than 120° C.

In yet another embodiment, the oven is in a humid atmosphere and said atmosphere contains sodium chloride and/or calcium gluconate dissolved in water.

The gluconate is dissolved, for example, at ambient temperature, at a concentration of less than 35 g·l⁻¹, for example of less than 33 g·l⁻¹.

Each of the passivation (stage 2) embodiments can be repeated several times (test 3 place 4), for example twice.

This passivation stage further reduces the amount of ions which there is a risk of being released subsequently into the contents of the container, in particular when the coating layer does not cover all or most of the internal surface of the container. It also advantageously prepares the internal face for the adhesion of the coating layer.

The passivation stage can also be carried out by a treatment known to a person skilled in the art under the atmospheric-pressure plasma name.

After this stage, a stage 5 of preparation and formation of a solution is carried out, if this was not carried out beforehand in parallel or furthermore, for example, in a separate place and in a period of time before its application which can reach several hours.

The stage of preparation comprises a stage of mixing the constituents of the layer. The mixing is carried out, for example, in a vat with a stirrer at a predetermined temperature and for a predetermined time, for example at a temperature of between 10° C. and 50° C., for example of between 15° C. and 35° C., for example 24° C. (ambient temperature), and mixed for a period of time of, for example, between 10 min and 1 h, for example of, for example, between 25 min and 45 min, for example 30 min.

The mixture comprises at least one solvent, a molecular precursor comprising alkoxy groups (alkoxyl group) and a catalyst, for example an aqueous catalyst.

The catalyst is an acid. In one embodiment, the acid is nitric acid, in another embodiment it is citric acid or a combination of the two.

The mixing is carried out successively and in the following order: solvent, then the aqueous liquid, that is to say successive addition of catalyst (acid), then optionally water and finally a silicate precursor (comprising silica Si).

The mixing is thus carried out in an aqueous liquid which makes possible the hydrolysis of the precursor and fluidifies the result obtained, making possible an easier application.

The solution has a concentration of nitric acid of between 2 mol/l and 3 mol/l, advantageously 2.5 mol/l, or of citric acid of between 0.02 mol/l and 0.8 mol/l, advantageously 0.19 mol/l.

The catalysis and the drying result in a gelling being obtained and then, as a function of the duration and of the temperature of drying, in a solidification being obtained.

In another embodiment, it is also possible to carry out a baking in order to give an even harder and/or firmer layer.

However, advantageously, there is no baking stage. The temperature can be increased during the drying, for example continuously, but remains less than a predetermined temperature, i.e. 300° C.

The absence of baking and/or drying at high temperature surprisingly makes it possible to reduce the porosity of the layer and of the material of the container, which reduces the subsequent releases of undesired particles into the contents of the container.

In the embodiments more particularly described here, the solvent is 2-butoxyethanol (hereinafter abbreviated to 2BOE).

In a first embodiment, the molecular precursor is 3-glycidoxypropyltrimethoxysilane. The acid used is then nitric acid.

The Sol-Gel thus obtained has a viscosity which makes its application in containers of complex shapes more difficult but makes possible better control of the covering, for example has a viscosity of less than 1 Pa·s at ambient temperature (approximately 24° C.)

In a second embodiment, the molecular precursor is tetraethyl orthosilicate known to a person skilled in the art under the abbreviated name TEOS and the catalyst is nitric acid.

Nitric acid makes possible good hydrolysis of the TEOS.

In a third embodiment, the precursor is tetraethyl orthosilicate and the catalyst is citric acid.

In this embodiment, the amount of water for dissolution of the citric acid is sufficient for there to be no other contributions of water.

Advantageously, the solvent (2BOE) and the precursor are mixed in proportions by weight of seven measures of solvent for one measure of water, two measures of acid at concentrations of, for nitric acid, between 10 mol/l and 18 mol/l, advantageously 15.55 mol/l, and, for citric acid, of less than 6 mol/l, for example less than 4 mol/l, for example between 0.5 mol/l and 4 mol/l, advantageously 3.12 mol/l, more advantageously 1.04 mol/l±0.5 mol/l, and two measures of precursor.

Measure is understood to mean volume.

This is because it is observed that the high concentration of acid has only a slight effect on the hydrolytic resistance of the wall of the covered container but, conversely, that a lower concentration makes it possible to better control and supervise the deposition of the mixture on a wall (gelling kinetics, viscosity, attachment of the Sol-Gel to the wall, and the like) and makes possible longer preservation of the mixture due to slower gelling/solidification kinetics.

In one embodiment, the proportions by volume of precursor and of acid are 1 volume for 1 volume, plus or minus 10%, under standard conditions.

The results of different TEOS precursor tests show that the deposition is cleaner with fewer smudges for citric acid concentrations<2 mol/l.

The use of other precursors gives favorable results for acid concentrations ranging up to 6 mol/l.

TABLE 1

| | Conditions of the test and | |
|---|---|---|
| Test | composition of the mixture | Results and comments |
| 1 | 42 ml 2BOE + 12 ml citric acid | Base formulation for |
| | (8 g citric acid + 20 ml | the comparisons |
| | water) + 12 ml TEOS | |
| 2 | 42 ml 2BOE + 12 ml citric acid | No improvement in |
| | (12 g citric acid + 20 ml | the hydrolytic |
| | water) + 12 ml TEOS | resistance |
| 3 | 42 ml 2BOE + 12 ml citric acid | Cleaner deposition, |
| | (4 g citric acid + 20 ml water | fewer smudges |
| | or 1.04 mol/l) + 12 ml TEOS | |
| 4 | 42 ml 2BOE + 12 ml citric acid | No improvement in |
| | (2 g citric acid + 20 ml | the qualities desired |
| | water) + 12 ml TEOS | in comparison with |
| | | test No. 3 |

Each line represents a test of formulation and of application of the corresponding solution, it being known that the table shows only the elements which have been modified for the tests, the other elements and/or parameters being identical between different tests.

It is seen that tests No. 3 and No. 4 not having the highest concentration of acid (4 g of acid for 20 ml of water or 2 g of acid for 20 ml of water) obtain better results than the other tests (for similar concentrations of TEOS precursor).

Furthermore, it has also been observed that the result is better for proportions of precursors, with respect to the volume of citric acid, of 1 or greater than 1 (for TEOS alone) to 11.45 times for other precursors.

In one embodiment, additives appropriate for performing a function are added to the mixture.

The functions can be to block contents/container and environment/contents interactions, such as to limit release, to color or add visual effects to the layer, to block radiation (for example UV radiation), to capture oxygen, to modify the surface activity or energy in order to influence the factors for sliding of the product over the wall of the container, to capture oxygen-comprising compounds and/or oxygen, and to increase security in biological terms (biocidal function, antibiotic function, and the like).

In one embodiment, a surfactant is added to the mixture. Surfactant is understood to mean a chemical agent which modifies the surface tension between the gelled mixture and the internal wall of the container on which it is deposited, making possible better adhesion of the mixture and better covering of the wall.

These functions are performed by addition, to the Sol-Gel in solution, of elements taken, for example, from the combination SiO₂, colored pigment, cerium oxide, silver and/or, as regards the surfactants, polyethylene glycol (i.e., the compounds known to a person skilled in the art under the PEG name (which are linear polyethers having a molar mass of less than 20 000 g/mol, the number bracketed with PEG denoting the molar mass of the compound under consideration, for example PEG 1500 is a polyethylene glycol with an average molar mass equal to 1500 g/mol)) and/or cetrimonium bromide (of chemical formula (C₁₆H₃₃)N(CH₃)₃Br), known under the name CTAB, and/or anionic surfactants, such as sodium lauryl sulfate (of chemical formula NaC₁₂H₂₅SO₄), known under the name SDS.

By way of example, a polyethylene glycol used is polyethylene glycol p-(1,1,3,3-tetramethylbutyl)phenyl ether, known under the name Triton X100™ from the American company Sigma-Aldrich.

The amount added is correlated with the nature of the function desired. For example, a blocking function can be produced by addition of SiO₂ in a concentration, for example, of between 3.5 g·l⁻¹ and 20 g·l⁻¹, for example of between 4.5 g·l⁻¹ and 18 g·l⁻¹, and/or a biocidal function can be produced by an addition of silver in a concentration, for example, of between 0.9 g·l⁻¹ and 2.5 g·l⁻¹, for example of between 1.1 g·l⁻¹ and 2.2 g·l⁻¹.

By way of example, for a mixture comprising 9 ml of solvent, 4 ml of acid and 4 ml of precursor mixed for a predetermined time of between 30 min and 1 h, surfactant, for example polyethylene glycol, is added in an amount of between 0.05 g and 0.2 g, for example of between 0.08 g and 0.15 g, for example 0.1 g, diluted in 5 ml of solvent and itself mixed for the same predetermined time.

After this stage, the process comprises a stage 6 of application of the solution in the course of gelling to at least a part of the internal surface of the container, for example ¾, and/or for a predetermined pattern (letters, product name, logos, and the like). The application thus forms a coating layer on said portion of the internal face.

The coating solution or gel is then evenly affixed to the internal surface of the container, so as to obtain a deposit with an even thickness, substantially identical at the chosen place.

Stage 6 can be performed in several ways and one embodiment of a device for application of the layer according to one embodiment of the invention will be more particularly described with reference to FIG. 2.

The application can be carried out immediately following the formation of the solution, after the start of gelling or may be postponed.

With respect to an end of the stage of preparation of the solution at a moment T0, the application can begin, for example, at a predetermined moment T0+h, h being a period of time in hours.

As the gel is substantially at the same temperature as that of the formation of the solution, a person skilled in the art will adjust the duration and conditions of storage, transportation and/or preparation before application of the postponed substance in order to obtain the rheological conditions (viscosity, coupling rate, adhesion, and the like) which are optimum and/or desired for the application envisaged, by noting that the change in viscosity follows the change in the duration.

For example, at ambient temperature, h is less than 10 h, for example less than 6 h, for example 3 h.

If the gel is stored at a predetermined temperature lower than the temperature of formation, the kinetics of the change in its physical chemical characteristics then being reduced, it can be stored for a subsequent application for several weeks.

For example, the storage time before use can have a predetermined duration of less than 4 days, for example of less than 2 days, in the embodiment with nitric acid and of less than 3 weeks, for example of less than 2 weeks, in the case of the use of citric acid.

The temperature is then, for example, less than 10° C., for example less than 5° C., for example 4° C.

After the stage of application, there follows a stage 7 of drying of the gel thus applied at a predetermined temperature and for a predetermined time, before optional baking.

In one embodiment, the containers comprising an opening are placed with the latter at the bottom in the vertical direction, so as to discharge the excess solution applied.

The containers are dried in an oven, for example a ventilated oven, at a predetermined temperature and for a predetermined time.

If the constituent material of the container is glass, the temperature is, for example, between 50° C. and 400° C., for example between 80° C. and 300° C., for example 200° C., for a drying time of between 15 min and 20 h, for example between 12 h and 15 h, at 80° C. and between 20 min and 40 min, for example 30 min, at 300° C.

If the constituent material of the container is plastic, the temperature is, for example, between 15° C. and 40° C., for example at ambient temperature, for a drying time of between 10 min and 120 min, for example 90 min.

The drying depends on the nature of the solvent, the drying time and the drying temperature having to be appropriate for the latter. In particular, the temperature has to be greater than the boiling point of the solvent at a predetermined pressure. For example, for 2BOE, the drying is carried out for a period of time of 20 to 30 min and at a temperature of greater than 172° C.

In another embodiment, the drying is carried out for a period of time mentioned above and at a temperature mentioned above but the containers are placed in an oven, for example a baking oven.

In one embodiment, after the drying, the process comprises a stage 8 of baking of the gel applied.

The baking is carried out in an oven, for example that which is used for the drying.

When the container is made of glass, it is baked, for example, for a period of time of 20 to 40 min, at a temperature of 450° C. to 550° C. when the acid is nitric acid and at a temperature of 530° C. to 600° C. when the acid is citric acid.

When the container is made of plastic, it is baked, for example, for a period of time of 40 to 60 min at a temperature of 90° C. to 150° C. when the acid is nitric acid or citric acid.

The successive stages of application of the solution (6) forming the coating product to a part of said internal face, of discharge of the excess coating solution and of drying (7) and/or baking (8) of the product can be repeated (test 9) a predetermined number n of times.

The number n is, for example, greater than or equal to two, for example greater than or equal to three, that is to say that the stages are repeated at least three times.

Once baked, the container is brought back to an ambient temperature along a predetermined temperature curve.

The downward curve in temperature of the container can be linear or stepwise, and, for example, follows an affine curve, for example, in order to bring the container back to an ambient temperature; the director coefficient of the (cooling) temperature curve is between 2° C./min and 5° C./min.

An excessively rapid lowering in temperature implies cracks on the coating layer and causes problems of adhesion and of differential expansion of the layer and of the wall of the container.

FIG. 2 shows a device 10 for coating at least a portion 11 of the internal surface 12 of a container 13, according to the embodiment of the invention more particularly described here.

The container 13 is, for example, a cylindrical bottle made of glass extending around an axis O_{z}. It comprises, at one of its ends 13 (top end), an opening 14 as a bottleneck. The opening of the bottleneck comprises a neck 15 with a smaller diameter than that of the container with a bottle.

The container thus substantially forms a chamber.

The device comprises a support 16 of the container, for example comprising a retention clamp 17 in the shape of a dish or of a U, the branches 18 of which grip the base 19, that is to say the bottom, of the container fixed via lateral screws (not represented).

Means 20 for rotating the container around its axis O_{z} at a predetermined speed S are provided. The speed S can be unchanging or variable and regulated. More specifically, the means comprise, for example, a rotating rod 21 for driving the support which extends along the axis O_{z} and a motor 22 for driving in a way known per se.

Means 24 for insertion/extraction (arrow 25) of a spraying tool or nozzle 26 inside the container are mounted on a frame B, as dot-and-dash lines in the figure, on the side of the bottleneck 15 of the container 13.

The nozzle 26 comprises a longitudinal shaft or tube 27 connected, at its end 28, to the insertion means 24 comprising an actuator 23 for longitudinal displacement, such as a jack.

The action of the jack, which is integral with the nozzle 26, relocates the latter from an initial position external to the container 13 to an operating position internal to the container along the axis O_{z}.

It thus makes possible a gradual descent, continuous or stepwise, of the tool for application of the coating solution (gel in formation) to the internal surface of the container.

The nozzle brings about vaporization 30 along a predetermined solid angle α for dispersion which depends on the ejection rate and pressure controlled in a way known per se.

The tube is connected, at its opposite end, to a system 31 for dispensing a liquid coating solution to be sprayed comprising means 32 for feeding with liquid or substantially liquid solution 33 in order to make possible the spraying, at a predetermined flow rate D.

The system 31 thus comprises a tank 34 for storage of said liquid and means 35 for moving the liquid (metering pump) arranged in order to regulate the flow rate D of the liquid via a calculator 36 and also controls the other actuators employed in the device.

The tank comprises, in its bottom, a mixing means, for example a stirrer (not represented).

The coating gel is a curable liquid coating material obtained by the Sol-Gel process described above.

The device also comprises means 37 for heating the container 13 known per se which make possible the rise in the temperature of a part of the internal surface of the container up to a predetermined temperature threshold.

More specifically, the heating of the internal surface is carried out, for example, by direct radiation from heating resistors 38 positioned outside the container or by diffusion around the wall of the container positioned in contact, for example, with a heating muffle (not represented).

In one embodiment, the container and the resistor are substantially confined in one and the same chamber so as to form an oven for homogeneous heating of the container.

The device also comprises a computer or automaton 39 for digital control comprising the calculator 36.

These are connected via a data Bus 40 and in a way known per se to the actuators of the device, namely to those of the retention clamp of the container, that is to say of the motor 22 for driving in rotation, to those of the means 24 for insertion of the nozzle 26 into the container (jack), the stirrer, and also to those of the means 35 for moving/feeding with liquid (pump, valve, nozzle) and heating means 37 (electrical resistors).

The calculator 36 is arranged in order to calculate, from the different set points imposed, a law for controlling each of the actuators in a way known per se.

FIG. 3 shows, in exploded partial view, an example of a container 41 coated with a layer 42 according to one embodiment of the invention, as obtained by the process described with reference to FIG. 1.

The container 41 is elongated, of the cylindrical bottle type with a bottleneck and is made of glass (but can also be made of plastic or metal, for example made of aluminum).

It comprises a sidewall 43 with a bottom 44 and a bottleneck 45 with its opening.

The sidewalls and the bottom comprise an external face 46 and an internal face 47.

In the embodiment more particularly described here, the whole of the internal face 47 is covered with the internal layer 42 with a substantially unchanging thickness.

The layer 42 also covers the internal face of the bottleneck 45.

The layer is the result of the drying of the solution and of the optional baking of the gel according to the invention. It forms a physical and chemical barrier to the constituent elements of the container and to the influence external to the container (light, temperature, and the like).

The solution and the resulting gel comprise SiO₂ and/or a colored pigment and/or silver and/or a cerium oxide.

This is because it is observed that the glass bottles treated according to the invention, for cosmetic, food or pharmaceutical use, have an improved resistance to aging and to atmospheric moisture, which also makes it possible to avoid the known phenomenon of exudation with air and thus to be able to use the treated bottles several years after treatments without having to clean them.

They also have a high hydrolytic resistance which makes it possible to increase the security of the contact with the product and/or to bring more aggressive products into contact.

Finally, with the process according to the invention, the bottles obtained exhibit an improved cleanliness of the internal surface, including by virtue of the removal of dust and particles.

It should be noted that the loss in weight between the solution initially applied and the persistent solid layer after drying and/or baking is high (division by the order of 20 and in all cases by at least a factor of 10).

For example, for 22 mg applied, there remains 1.2 mg of matter after drying and baking.

The results obtained with the embodiment of the process more particularly described above with reference to FIG. 1, with 100 ml cylindrical glass bottles and a single series of stages 5 to 8 using the standardized ISO measurement protocol, have been given below in the form of two tables, namely a table 2 (without prior passivation) and a table 3 (with prior passivation).

Each test corresponds (Treatment conditions column) to a gelifiable solution, the composition parameters of which are specified, and for given temperature and duration conditions of stages 5 to 8.

The “HR results” column gives the hydrolytic resistance values during successive measurements (for example there were 6 measurements for test 8 of table 1).

For one and the same “test”, and if there is good reason, the measurements are then averaged in the “Mean of the HR values” column. Each mean is compared with the measurement of a reference (identical container and measurement of its HR without treatment according to the process according to the invention averaged over fifteen measurements), said mean being 0.12.

The reference conditions are those regarded above as the standard conditions giving a homogeneous base hydrolytic resistance R0 without prior treatment.

TABLE 2
(without prior passivation stage 2):
In the “Treatment conditions” below, only the different
elements between each “Test” appear, the common elements of
the mixture for the deposition being: mixture of 7 measures of 2BOE
with 2 measures of TEOS and 1.25 measures of water. For its part,
the citric acid is at a concentration of the order of 1 mol/l.

| | | | Mean of |
|---|---|---|---|
| | | | the HR |
| Test | Treatment conditions | HR results | values |
| 1 | Deposition of the layer with a | 0.05 | 0.08 |
| | low SiO₂ charge (4.5 g/l) at T0 + | 0.1 | |
| | 3 h and baking at 500° C. | 0.1 | |
| 2 | Deposition at T0 + 3 h with a | 0.08 | 0.07 |
| | high SiO₂ charge (18 g/l) and | 0.08 | |
| | baking at 500° C. | 0.06 | |
| 3 | With citric acid | 0.07 | 0.03 |
| | Stage of drying in an oven at | 0.03 | |
| | 80° C. for 12 h and then baking at | 0.03 | |
| | 580° C. in an autoclave for 30 min | | |
| 4 | With citric acid | 0.01 | 0.01 |
| | Stage of baking at 580° C. for | 0.01 | |
| | 30 min with a stationary phase | 0.02 | |
| | at 300° C. for 30 min | 0.38 | |
| | | 0.07 | |
| | | 0.1 | |
| | | 0.1 | |

It is seen that, on the one hand, the addition of citric acid improves the resistivity and, on the other hand, that better results are obtained in the test without intermediate drying.

TABLE 3
(with prior passivation stage 2):
Under the “Treatment conditions” below, only the
different elements between each “Test” appear, the
common elements of the mixture being: mixture of 7
measures of 2BOE with 2 measures of TEOS and 1.25
measures of water.

| | | | Mean of |
|---|---|---|---|
| Test | Treatment conditions | HR results | HR values |
| 1′ | Pretreatment with calcium | 0.1 | 0.06 |
| | gluconate with a concentration | 0.05 | |
| | of 33 g · l⁻¹ in an oven at 90° C. | 0.04 | |
| | for 1 h and then deposition with | | |
| | nitric acid | | |
| 2′ | Pretreatment three times by | 0.02 | 0.02 |
| | autoclave at 121° C. for 1 h with | 0.01 | |
| | water of R1 quality and | | |
| | container stoppered with | | |
| | aluminum-with water change | | |
| | between each cycle, then | | |
| | deposition with citric acid, | | |
| | then stage of drying in an oven | | |
| | at 80° C. for 12 h and stage of | | |
| | baking at 580° C. for 30 min | | |
| 3′ | Idem “Test 2” with three | 0.03 | 0.04 |
| | successive depositions | 0.05 | |
| | | 0.05 | |

It is also seen that the process according to the invention makes it possible to systematically obtain a significant difference with the reference of the order of 0.1 on average without prior passivation and of 0.04 with passivation. The hydrolytic resistance and thus the capacity for release, which is proportional to it, are thus improved by the order of 50% to 80% with prior passivation.

It is also seen that the measurements carried out reveal that the embodiment of test 4, in which the process is carried out by deposition of a Sol-Gel with seven measures of 2BOE, two measures of citric acid and two measures of TEOS, with baking at 580° C. for 30 min while observing a stationary phase at 300° C. for 30 min, makes it possible to reduce the hydrolytic resistance by close to ten times with respect to test 1 and thus to reduce by a factor of ten the release into the product contained by the bottle, at the same conditions.

In FIG. 4A, blisters 48 and cracks 49 appear in the deposited and dried layer of solution 50.

In order to make possible better attachment and hold of the layer 50 and also to very significantly improve the homogeneity of the layer, which considerably increases the hydrolytic resistance of the resulting wall, it is possible to add surfactant elements to the mixture forming the Sol-Gel.

FIG. 4B shows, under the same conditions (formulation, concentration, drying time, mixing time, method of deposition, and the like) as those of FIG. 4A, the result of such an addition of surfactant, in this instance a product known under the name PEG 1500.

The surface density of blisters 48 and of cracks 49 is then to a very great extent lower than the corresponding density without addition of surfactant, for example in a ratio greater than 40.

As is obvious and as also results from the above, the present invention is not limited to the embodiments more particularly described. On the contrary, it encompasses all the alternative forms thereof and in particular those as a function of the material (type of glass, of plastic, of ceramic or other) and of the results desired, where the cycle numbers, the temperatures and the durations are determined differently, those where the container is a jar, those where the heated regions themselves comprise subregions of variation in the temperature in the fall and/or in the rise of said temperatures, and those where the proportions envisaged vary by the order of less than 20%.

1. A process for the manufacture of a coating layer for the internal face of a container made of glass or of plastic suitable for containing products biocompatible with man and/or animals, in which:
a solution containing a solvent, water, a molecular precursor comprising alkoxyl groups and an acid as catalyst is formed,
this solution is mixed in order to initiate the hydrolysis and the condensation,
wherein, the acid being citric acid,
the solution thus obtained is applied to at least a part of the internal face of the container, the solution being in the course of hydrolysis and condensation, and
the solution thus applied is dried at a predetermined temperature and for a predetermined time.

2. The process as claimed in claim 1, wherein the drying is carried out simultaneously with the application.

3. The process as claimed in claim 1, wherein the drying is subsequently followed by a stage of baking within a higher predetermined temperature range.

4. The process as claimed in claim 1, wherein, before application, a surfactant is added to the solution.

5. The process as claimed in claim 4, wherein the surfactant is taken from: polyethylene glycol and/or cetrimonium bromide and/or anionic surfactants and/or polyethylene glycol p-(1,1,3,3-tetramethylbutyl)phenyl ether.

6. The process as claimed in claim 1, wherein drying is carried out at a temperature greater than the boiling point of the solvent and of the acid for a time of greater than 20 min while ventilating the interior of the container.

7. (canceled)

8. The process as claimed in claim 1, wherein the solution has a concentration of citric acid of between 0.02 mol/l and 0.8 mol/l.

9. The process as claimed in claim 1, wherein, before application of the solution to the internal face, the extractable materials are extracted beforehand from said internal face by at least three passes in an autoclave with water of R or R1 quality and/or water charged with NaCl according to a concentration of between 0.5% and 1.2% by weight.

10. The process as claimed in claim 1, wherein, before application of the solution to the internal face, the extractable materials are extracted beforehand from said internal face by treatment in an oven in a humid atmosphere containing sodium chloride and/or calcium gluconate dissolved in water in proportions sufficient to make possible complete dissolution of the molecules concerned.

11. The process as claimed in claim 3, wherein, the container being made of glass, it is baked at a temperature of 530° C. to 600° C. for a period of time of 20 to 40 min.

12. The process as claimed in claim 3, wherein, the container being made of plastic, it is baked at a temperature of 90° C. to 150° C. for a period of time of 40 to 60 min.

13. The process as claimed in claim 1, wherein use is made, as precursor, of 3-glycidoxypropyltrimethoxysilane or of tetraethyl orthosilicate.

14. The process as claimed in claim 1, wherein use is made, as solvent, of 2-butoxyethanol.

15. The process as claimed in claim 1, wherein the solvent and the precursor are mixed in a proportion of seven measures of solvent for one measure of water, two measures of acid at a concentration of between 0.5 mol/l and 4 mol/l and two measures of precursor.

16. The process as claimed in claim 1, wherein additives suitable for carrying out a function taken from the combination of SiO₂, colored pigment, cerium oxide and/or silver are added to the mixture.

17. The process as claimed in claim 1, wherein, after addition of the ingredients, mixing is carried out for a period of time t of between 25 and 45 minutes at a temperature of between 15° C. and 35° C.

18. The process as claimed in claim 1, wherein the successive stages of application of the coating liquid to at least a part of said internal face, of discharge of the excess coating product and of drying of the product are repeated at least three times.

19. The process as claimed in claim 1, wherein the solvent, the acid catalyst, the water and then the molecular precursor are successively mixed in order.

20. The process as claimed in claim 1, wherein a treatment with an atmospheric-pressure plasma is carried out beforehand.

21. A container made of glass or of plastic comprising a wall delimiting a cavity suitable for containing products biocompatible with man and/or animals, said wall exhibiting an internal face facing said cavity, at least a part of which is covered with a layer of solidified gel obtained from a solution containing a solvent, water, a molecular precursor comprising alkoxy groups and an acid as catalyst, wherein the layer is obtained by the process as claimed in claim 1, the acid being citric acid.

22. The container as claimed in claim 20, wherein the solution comprises SiO₂, a colored pigment, cerium oxide and/or silver.

23. The process as claimed in claim 1, wherein the solution in the course of hydrolysis and of condensation is applied to the internal face of said container after said mixing, without intermediate filtration or addition of solvent between said mixing and said application.

24. The process as claimed in claim 1, wherein the citric acid has a concentration in water of less than or equal to 6 mol/l and wherein, for one unit by volume of water at said concentration of acid, the solution comprises between 1 and 12 units by volume of precursor.

25. The process as claimed in claim 24, wherein the concentration of citric acid in water is less than 2 mol/l.
